(19) United States
(12) Patent Application Publication
(10) Pub. No.: US 2013/0148811 A1
(43) Pub. Date: Jun. 13, 2013

(54) Electronic Devices, Methods, and Computer Program Products for Determining Position Deviations in an Electronic Device and Generating a Binaural Audio Signal Based on the Position Deviations

(71) Applicant: Georg Siotis, Lund (SE)

(72) Inventor: Georg Siotis, Lund (SE)

(73) Assignee: Sony Ericsson Mobile Communications AB

(21) Appl. No.: 13/348,160

(22) Filed: Jan. 11, 2012

Related U.S. Application Data
(60) Provisional application No. 61/568,378, filed on Dec. 8, 2011.

(51) Int. Cl. H04R 5/00

(52) U.S. Cl. 381/17

(57) ABSTRACT

An electronic device includes an audio input module that is configured to determine a baseline audio position for the electronic device, receive at least one position offset input signal, and determine a position offset of the electronic device relative to the baseline audio position based on the at least one position offset input signal and an audio three-dimensional (3D) engine that is configured to generate a binaural audio signal based on the position offset of the electronic device.

### CROSS-REFERENCE TO RELATED APPLICATION

This application claims the benefit of U.S. Provisional Patent Application No. 61/568,378, filed on Dec. 8, 2011, in the U.S. Patent and Trademark Office, the disclosure of which is incorporated herein in its entirety by reference.

### BACKGROUND OF THE INVENTION

The present invention relates to electronic devices, and, more particularly, to electronic devices, methods, and computer program products for generating a binaural audio signal.

When recording an audio event, a user may involuntarily move the recording device, such as a mobile phone, which may distort the audio image during playback such that the accuracy of the binaural affect is diminished. Unfortunately, it may be difficult to maintain a steady positioning of a recording device as, in the case of a mobile phone, for example, the recording device may be relatively small and handheld rather than supported by a stabilization system, such as a tripod. Human hearing may be sensitive to position deviations in an audio recording device of as little as three degrees. Thus, if an accurate binaural effect is desired during playback, it may be desirable to reduce or compensate for positional deviations in a recording device when an audio recording is being made.

### SUMMARY

According to some embodiments of the present invention, an electronic device comprises an audio input module that is configured to determine a baseline audio position for the electronic device, receive at least one position offset input signal, and determine a position offset of the electronic device relative to the baseline audio position based on the at least one position offset input signal and an audio three-dimensional (3D) engine that is configured to generate a binaural audio signal based on the position offset of the electronic device.

In other embodiments, the at least one position offset input signal comprises a video signal.

In still other embodiments, the at least one position offset input signal comprises an accelerometer signal.

In still other embodiments, the at least one position offset input signal comprises a compass signal.

In still other embodiments, the at least one position offset input signal comprises a gyroscope signal.

In still other embodiments, the audio input module is further configured to determine a new baseline audio position for the electronic device when the position offset of the electronic device is a directional deviation of greater than a new position threshold from the baseline audio position of the electronic device. The audio input module is further configured to determine the position offset of the electronic device relative to the new baseline audio position.

In still other embodiments, the audio input module is further configured to low pass filter the position offset of the electronic device to discard changes in the position offset of the electronic device that occur at a frequency greater than a high frequency threshold to generate a filtered position offset of the electronic device. The audio 3D engine is configured to generate the binaural audio signal based on the filtered position offset of the electronic device.

In still other embodiments, the audio input module is further configured to process the position offset of the electronic device with a hysteresis filter to generate a filtered position offset of the electronic device. The audio 3D engine is configured to generate the binaural audio signal based on the filtered position offset of the electronic device.

In still other embodiments, the electronic device is a mobile terminal.

In further embodiments of the present invention, an electronic device is operated by determining a baseline audio position for the electronic device, receiving at least one position offset input signal, determining a position offset of the electronic device relative to the baseline audio position based on the at least one position offset input signal, and generating a binaural audio signal based on the position offset of the electronic device.

In still further embodiments of the present invention, the at least one position offset input signal comprises a video signal.

In still further embodiments, the at least one position offset input signal comprises an accelerometer signal.

In still further embodiments, the at least one position offset input signal comprises a compass signal.

In still further embodiments, the at least one position offset input signal comprises a gyroscope signal.

In still further embodiments, the method further comprises determining a new baseline audio position for the electronic device when the position offset of the electronic device is a directional deviation of greater than a new position threshold from the baseline audio position of the electronic device. The determining of the position offset of the electronic device comprises determining the position offset of the electronic device relative to the new baseline audio position.

In still further embodiments, the method further comprises low pass filtering the position offset of the electronic device to discard changes in the position offset of the electronic device that occur at a frequency greater than a high frequency threshold to generate a filtered position offset of the electronic device. Generating the binaural audio signal comprises generating the binaural audio signal based on the filtered position offset of the electronic device.

In still further embodiments, the method further comprises processing the position offset of the electronic device with a hysteresis filter to generate a filtered position offset of the electronic device. Generating the binaural audio signal comprises generating the binaural audio signal based on the filtered position offset of the electronic device.

In still further embodiments, the electronic device is a mobile terminal.

In other embodiments of the present invention, a computer program product for operating an electronic device comprises a computer readable storage medium having computer readable program code embodied therein. The computer readable program code comprises computer readable program code configured to determine a baseline audio position for the electronic device; computer readable program code configured to receive at least one position offset input signal; computer readable program code configured to determine a position offset of the electronic device relative to the baseline audio position based on the at least one position offset input signal; and computer readable program code configured to generate a binaural audio signal based on the position offset of the electronic device.

In still other embodiments, the at least one position offset input signal comprises at least one of a video signal, an accelerometer signal, a compass signal, and a gyroscope signal.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates an electronic device/mobile terminal in accordance with some embodiments of the present invention;

FIG. 2 is a block diagram that illustrates an audio input module and audio three-dimensional (3D) engine in accordance with some embodiments of the present invention; and

FIGS. 3 and 4 are flow charts that illustrate determining position deviations in an electronic device and generating a binaural audio signal that is based on the position deviations in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

For purposes of illustration, embodiments of the present invention are described herein in the context of a mobile terminal. It will be understood, however, that the present invention is not limited to such embodiments and may be embodied generally as an electronic device where position deviations in the electronic device can be determined and a binaural audio signal may be generated that is based on the position deviations.

Some embodiments of the present invention stem from a realization that when making an audio recording where it is desirable to provide a binaural effect during playback, minor deviations in the position of the recording device may distort binaural effect of the audio recording during playback. With many mobile terminals providing both audio and video recording capabilities, audio recordings may be made where a user is holding the mobile terminal and directing video camera and microphones towards a target. It may be difficult, however, for a user to maintain a steady position when recording.

According to some embodiments of the present invention, an electronic device, such as a mobile terminal, may include an audio input module that can determine a baseline audio position for the electronic device at the beginning of an audio recording, for example. The audio input module may receive one or more position offset input signals and may determine a position offset of the electronic device relative to the baseline audio position based on the offset input signal(s). This position offset determined by the audio input module may then be provided to an audio three-dimensional (3D) engine that generates a binaural audio signal based on the position offset received from the audio input module. In accordance with various embodiments of the present invention, the position offset input signals may include, but are not limited to, a video signal, an accelerometer signal, a compass signal, and a gyroscope signal. By providing the audio 3D engine with position offset information of the recording device relative to an original position used to start the recording, for example, the audio 3D engine may be able to compensate for these positional deviations when generating the output binaural audio signal so as to provide improved binaural reproduction of the target audio performance. This may be useful when a user finds it difficult to maintain a recording device that is part of a mobile terminal, for example, in a steady position due to fatigue, being bumped by other people or objects, instability in a structure supporting the user, and/or other factors that may contribute to deviations in the position of the recording device.

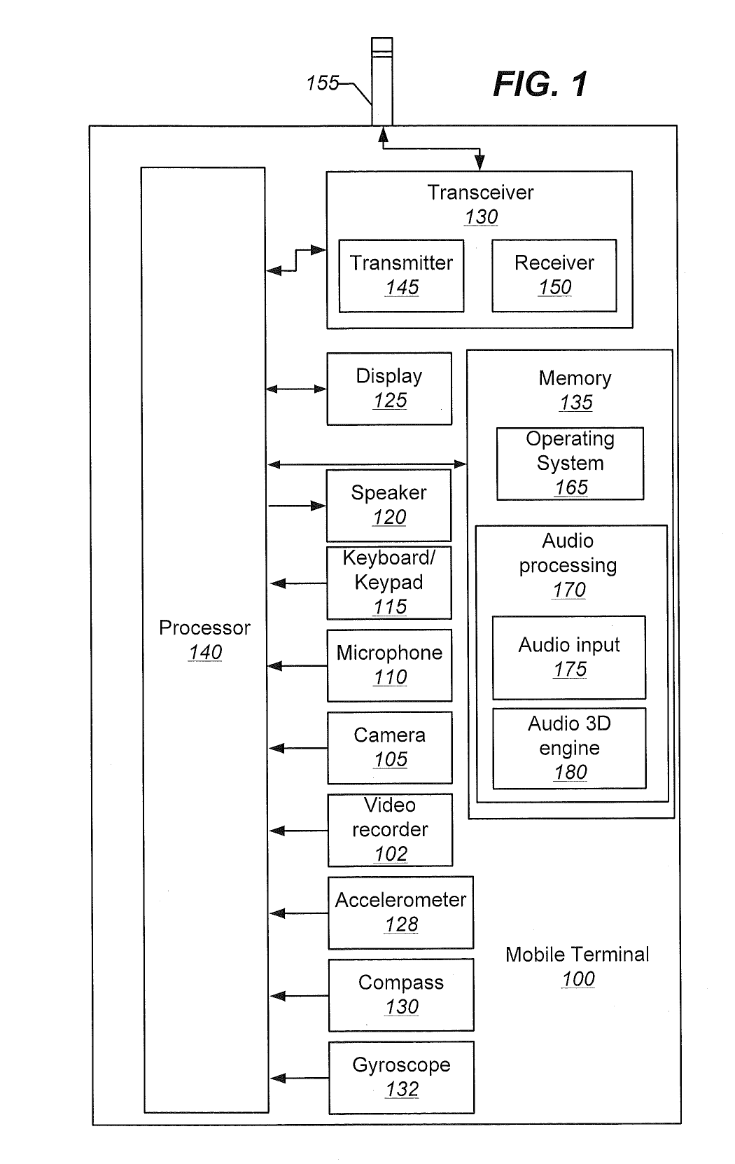

Referring now to FIG. 1, an exemplary mobile terminal 100, in accordance with some embodiments of the present invention, comprises a video recorder 102, a camera 105, a microphone 110, a keyboard/keypad 115, a speaker 120, a display 125, a gyroscope 132, a compass 130, an accelerometer 128, a transceiver 130, and a memory 135 that communicate with a processor 140. The transceiver 130 comprises a transmitter circuit 145 and a receiver circuit 150, which respectively transmit outgoing radio frequency signals to base station transceivers and receive incoming radio frequency signals from the base station transceivers via an antenna 155. The radio frequency signals transmitted between the mobile terminal 100 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 100 may be included in many conventional mobile terminals and their functionality is generally known to those skilled in the art.

The processor 140 communicates with the memory 135 via an address/data bus. The processor 140 may be, for example, a commercially available or custom microprocessor. The memory 135 is representative of the one or more memory devices containing the software and data used to determine position deviations in an electronic device can and to generate a binaural audio signal that is based on the position deviations, in accordance with some embodiments of the present invention. The memory 135 may include, but is not limited to, the following types of devices: cache, ROM, PROM, EPROM, EEPROM, flash, SRAM, and DRAM.

As shown in FIG. 1, the memory 135 may contain up to two or more categories of software and/or data: the operating system 165 and an audio processing module 170. The operating system 165 generally controls the operation of the mobile terminal 100. In particular, the operating system 165 may manage the mobile terminal's software and/or hardware resources and may coordinate execution of programs by the processor 140. The audio processing module 170 comprises an audio input module 175 and an audio 3D engine 180. The audio processing module may be configured to process audio signals recorded through one or more microphones 110. In particular, the audio input module 175 may be configured to determine an initial baseline audio position for the mobile terminal 100 and to process one or more position offset input signals, such as, for example, signals from the video recorder 102, accelerometer 128, compass 130, and gyroscope 132. The audio input module 175 may process these position offset input signal(s) to generate a position offset of the mobile terminal 100 relative to the originally determined baseline audio position.

The audio 3D engine may be configured to generate a binaural audio signal based on the position offset of the mobile terminal 100 provided by the audio input module 175. The audio 3D engine may use the position offset to compensate for movement of the mobile terminal 100 when making an audio recording to reduce the distorting effects the movement may have on the binaural audio signal.

Although FIG. 1 illustrates an exemplary software and hardware architecture that may be used to determine position deviations in an electronic device and to generate a binaural audio signal that is based on the position deviations, it will be understood that the present invention is not limited to such a configuration but is intended to encompass any configuration capable of carrying out the operations described herein.

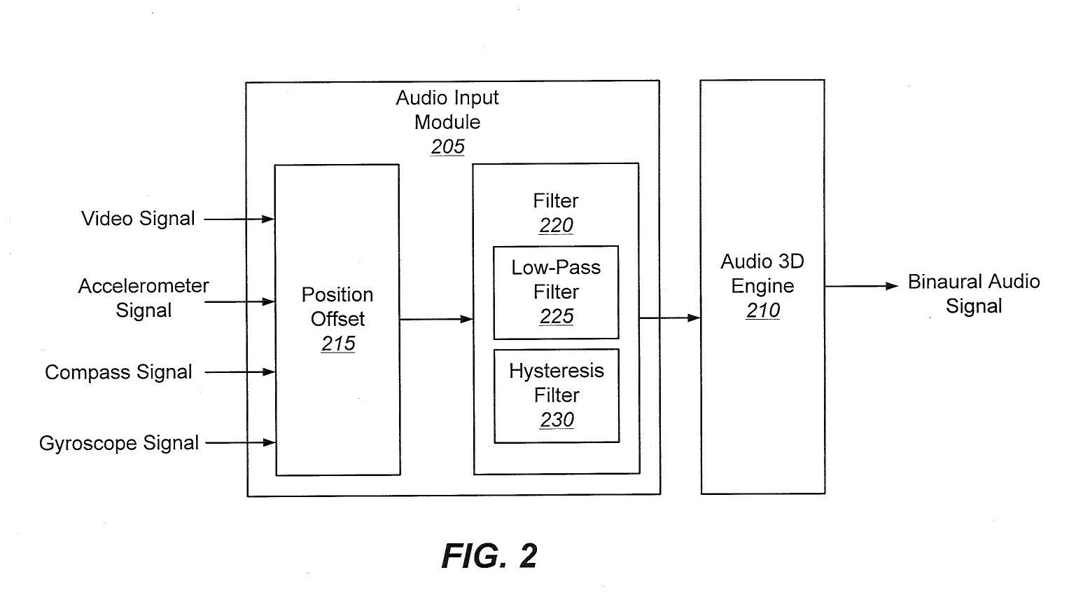

FIG. 2 is a block diagram that illustrates the audio input module 175 and audio 3D engine 180 of FIG. 1 in accordance with some embodiments of the present invention. The audio input module 205 and the audio 3D engine 210 shown in FIG. 2 correspond to the audio input module 175 and the audio 3D engine 180 of FIG. 1, respectively. The audio input module 205 comprises a position offset module 215 and a filter module 220 that are connected as shown. The position offset module 215 is configured to receive one or more position offset input signals, which may include a video signal, an accelerometer signal, a compass signal, and/or a gyroscope signal in accordance with some embodiments of the present invention, and generate a position offset of an electronic device, such as the mobile terminal 100 of FIG. 1, relative to a baseline audio position for the electronic device based on one or more of the position offset input signals. In accordance with various embodiments of the present invention, the position offset module 215 may apply different weightings to the position offset input signal(s) based on the environmental conditions associated with the electronic device. For example, if an audio recording is being made in a dark environment, then the video signal may be less useful in determining changes in position of the electronic device doing the recording. Similarly, if an audio recording is being made in the presence of a relatively strong electromagnetic field, then the compass signal may be less useful in determining changes in position of the electronic device doing the recording due to electromagnetic interference.

The position offset determined by the position offset module 215 may be processed by the filter module 220 to remove high frequency changes in the position offset determinations so as to discard, for example, vibrations in the electronic device performing the audio recording. The position offset determinations output from the position offset module 215 may be processed using a low pass filter 215 that discards or blocks changes in the position offset values that occur at a frequency above a high frequency threshold that is set for the electronic device 100. The position offset determinations output from the position offset module 215 may also be processed using a hysteresis filter 230 to block undesired rapid changes in the position offset determinations. In accordance with various embodiments of the present invention, the position offset determinations may be processed using the low-pass filter 225, the hysteresis filter 230, or both the low-pass filter 225 and the hysteresis filter 230 to generate filtered position offset values that are provided to the audio 3D engine 210. The audio 3D engine 210 generates the binaural audio signal by incorporating the position offset values output from the audio input module 205 so as to compensate for movement of the mobile terminal 100 and reduce the effects of such movement of the mobile terminal 100 on the binaural audio signal.

Although FIGS. 1 and 2 illustrate exemplary hardware/software architectures that may be used in mobile terminals, electronic devices, and the like to determine position deviations in an electronic device and to generate a binaural audio signal that is based on the position deviations, it will be understood that the present invention is not limited to such a configuration but is intended to encompass any configuration capable of carrying out operations described herein. Moreover, the functionality of the hardware/software architecture of FIGS. 1 and 2 may be implemented as a single processor system, a multi-processor system, or even a network of stand-alone computer systems, in accordance with various embodiments of the present invention.

Computer program code for carrying out operations of devices and/or systems discussed above with respect to FIGS. 1 and 2 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, mobile terminals, electronic devices, and/or computer program products in accordance with some embodiments of the invention.

These flowchart and/or block diagrams further illustrate exemplary operations of determining position deviations in an electronic device and generating a binaural audio signal that is based on the position deviations, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

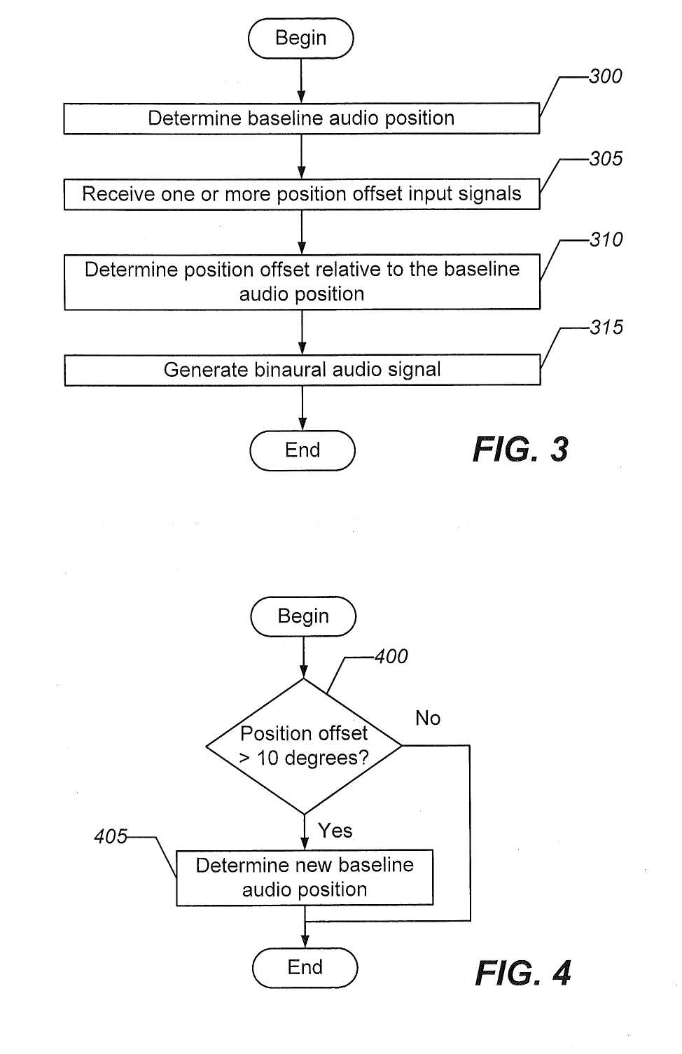

Referring now to FIG. 3, operations used to determine position deviations in an electronic device and to generate a binaural audio signal that is based on the position deviations begin at block 300 where the audio input module 175, 205 determines a baseline audio position. At block 305, the audio input module 175, 205 receives one or more position offset input signals, such as a video signal, accelerometer signal, compass signal, and/or a gyroscope signal. The audio input module 175, 205 determines a position offset of the electronic device relative to the baseline audio position at 310.

In some embodiments of the invention illustrated in FIG. 4, if the position offset relative to the baseline audio position is greater than a new position threshold with respect to any direction, then it may be assumed that a user wishes to establish a new baseline audio position from which to make a recording. For example, a user could start recording a performance from one seat and subsequently move to a different seat having a different vantage point with respect to the performer(s). Referring now to FIG. 4, the position offset module 215 may evaluate at block 400 whether the determined position offset of the electronic device relative to the baseline audio position is greater than a new position threshold in any direction, which in some embodiments, may be 10 degrees. If so, then a new baseline audio position may be determined based on the current position of the electronic device 100 at block 405.

Returning to FIG. 3, once the position offset is determined relative to the baseline audio position at block 310, the position offset is provided to the audio 3D engine 210 at block 315 where the position offset is used to generate a binaural audio signal by taking into account movement of the mobile terminal 100 so as to reduce the effects thereof with respect to the binaural quality of the recorded audio signal.

Thus, an electronic device, such as a mobile terminal, equipped with an audio input module and audio 3D engine in accordance with the embodiments described above may allow a user to make an audio recording with improved binaural audio quality as the undesired effects of unintentional movement of the electronic device during recording may be at least partially compensated for.

The flowcharts of FIGS. 3 and 4 illustrate the architecture, functionality, and operations of embodiments of methods, electronic devices, and/or computer program products for determining position deviations in an electronic device and generating a binaural audio signal that is based on the position deviations. In this regard, each block represents a module, segment, or portion of code, which comprises one or more executable instructions for implementing the specified logical function(s). It should also be noted that in other implementations, the function(s) noted in the blocks may occur out of the order noted in FIGS. 3 and 4. For example, two blocks shown in succession may, in fact, be executed substantially concurrently or the blocks may sometimes be executed in the reverse order, depending on the functionality involved.

Many variations and modifications can be made to the exemplary embodiments without substantially departing from the principles of the present invention. All such variations and modifications are intended to be included herein within the scope of the present invention, as set forth in the following claims.

That which is claimed:

1. An electronic device, comprising:
an audio input module that is configured to determine a baseline audio position for the electronic device, receive at least one position offset input signal, and determine a position offset of the electronic device relative to the baseline audio position based on the at least one position offset input signal; and
an audio three-dimensional (3D) engine that is configured to generate a binaural audio signal based on the position offset of the electronic device.

2. The electronic device of claim 1, wherein the at least one position offset input signal comprises a video signal.

3. The electronic device of claim 1, wherein the at least one position offset input signal comprises an accelerometer signal.

4. The electronic device of claim 1, wherein the at least one position offset input signal comprises a compass signal.

5. The electronic device of claim 1, wherein the at least one position offset input signal comprises a gyroscope signal.

6. The electronic device of claim 1, wherein the audio input module is further configured to determine a new baseline audio position for the electronic device when the position offset of the electronic device is a directional deviation of greater than a new position threshold from the baseline audio position of the electronic device; and
wherein the audio input module is further configured to determine the position offset of the electronic device relative to the new baseline audio position.

7. The electronic device of claim 1, wherein the audio input module is further configured to low pass filter the position offset of the electronic device to discard changes in the position offset of the electronic device that occur at a frequency greater than a high frequency threshold to generate a filtered position offset of the electronic device;
wherein the audio 3D engine is configured to generate the binaural audio signal based on the filtered position offset of the electronic device.

8. The electronic device of claim 1, wherein the audio input module is further configured to process the position offset of the electronic device with a hysteresis filter to generate a filtered position offset of the electronic device;
wherein the audio 3D engine is configured to generate the binaural audio signal based on the filtered position offset of the electronic device.

9. The electronic device of claim 1, wherein the electronic device is a mobile terminal.

10. A method of operating an electronic device, comprising:
determining a baseline audio position for the electronic device;
receiving at least one position offset input signal;
determining a position offset of the electronic device relative to the baseline audio position based on the at least one position offset input signal; and
generating a binaural audio signal based on the position offset of the electronic device.

11. The method of claim 10, wherein the at least one position offset input signal comprises a video signal.

12. The method of claim 10, wherein the at least one position offset input signal comprises an accelerometer signal.

13. The method of claim 10, wherein the at least one position offset input signal comprises a compass signal.

14. The method of claim 10, wherein the at least one position offset input signal comprises a gyroscope signal.

15. The method of claim 10, further comprising:
determining a new baseline audio position for the electronic device when the position offset of the electronic device is a directional deviation of greater than a new position threshold from the baseline audio position of the electronic device;
wherein determining the position offset of the electronic device comprises determining the position offset of the electronic device relative to the new baseline audio position.

16. The method of claim 10, further comprising:
low pass filtering the position offset of the electronic device to discard changes in the position offset of the electronic device that occur at a frequency greater than a high frequency threshold to generate a filtered position offset of the electronic device; and
wherein generating the binaural audio signal comprises generating the binaural audio signal based on the filtered position offset of the electronic device.

17. The method of claim 10, further comprising:
processing the position offset of the electronic device with a hysteresis filter to generate a filtered position offset of the electronic device;
wherein generating the binaural audio signal comprises generating the binaural audio signal based on the filtered position offset of the electronic device.

18. The method of claim 10, wherein the electronic device is a mobile terminal.

19. A computer program product for operating an electronic device, comprising:
a computer readable storage medium having computer readable program code embodied therein, the computer readable program code comprising:
computer readable program code configured to determine a baseline audio position for the electronic device;
computer readable program code configured to receive at least one position offset input signal;
computer readable program code configured to determine a position offset of the electronic device relative to the baseline audio position based on the at least one position offset input signal; and
computer readable program code configured to generate a binaural audio signal based on the position offset of the electronic device.

20. The computer program product of claim 19, wherein the at least one position offset input signal comprises at least one of a video signal, an accelerometer signal, a compass signal, and a gyroscope signal.
